(19) United States
(12) Patent Application Publication
(10) Pub. No.: US 2023/0091063 A1
(43) Pub. Date: Mar. 23, 2023

(54) SYSTEMS AND METHODS FOR REAL-TIME PROCESSING OF RESOURCE REQUESTS

(71) Applicant: The Toronto-Dominion Bank, Toronto (CA)

(72) Inventors: Michele Denise SCHULTZ, Quinte West (CA); Sasha RADULOVICH, Oakville (CA)

(73) Assignee: The Toronto-Dominion Bank, Toronto (CA)

(21) Appl. No.: 17/477,605

(22) Filed: Sep. 17, 2021

(51) Int. Cl. G06Q 40/02; G06Q 20/10; G06Q 20/04; H04M 1/724

(52) U.S. Cl. CPC G06Q 40/025; G06Q 20/108; G06Q 20/047; H04M 1/724

(57) ABSTRACT

A method for real-time processing of resource requests is disclosed. The method includes: receiving a first request to obtain a first quantity of resources in connection with a data record; identifying a first set of parameter values for the first request, the first set including at least one automatically modifiable parameter value; determining first criteria for evaluating the first request, the first criteria including defined rules associated with one or more of the first set of parameter values; determining that the first request does not satisfy the first criteria; in response to determining that the first request does not satisfy the first criteria: determining modifications to at least one parameter value of the first set to obtain a second set of parameter values for a second request that satisfies the first criteria; and generating a notification indicating the second set of parameter values.

### TECHNICAL FIELD

The present disclosure relates to data processing systems and, in particular, to systems and methods for real-time processing of resource requests.

### BACKGROUND

Resource servers, or servers that are associated with resource lender entities, may receive and process resource requests from various computing systems. Such servers may automatically process resource requests and provide lending decisions to requesting entities (e.g., acquirer of assets). The resource requests are typically associated with resource accounts. In particular, a borrower entity may request to receive a transfer of resources (e.g., data, computing resources, etc.) to one or more data records associated with a resource account of the borrower entity. Manual processing of resource requests data may result in unintended errors or delays. Any delays which may be introduced by such manual processing can cause subsequent processes and actions to be delayed or to fail entirely.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment of the present disclosure;

FIG. 2A is a high-level schematic diagram of an example computing device;

FIG. 2B shows a simplified organization of software components stored in memory of the example computing device of FIG. 2A;

FIG. 3 shows, in flowchart form, an example method for real-time processing resource requests;

FIG. 4 shows, in flowchart form, an example method for determining request data for one or more alternative resource requests;

FIG. 5 shows, in flowchart form, an example method for providing display data of a user interface for requesting resources; and

FIG. 6 shows, in flowchart form, an example method for dynamically updating adjudication rules for a resource request processing system.

Like reference numerals are used in the drawings to denote like elements and features.

### DETAILED DESCRIPTION OF EXAMPLE EMBODIMENTS

In one aspect, the present disclosure describes a computing system. The computing system includes a processor, a communications module coupled to the processor, and a memory coupled to the processor. The memory stores instructions that, when executed, configure the processor to: receive a first request to obtain a first quantity of resources in connection with a data record; identify a first set of parameter values for the first request, the first set including at least one automatically modifiable parameter value; determine first criteria for evaluating the first request, the first criteria including defined rules associated with one or more of the first set of parameter values; determine that the first request does not satisfy the first criteria; in response to determining that the first request does not satisfy the first criteria: determine modifications to at least one parameter value of the first set to obtain a second set of parameter values for a second request that satisfies the first criteria; and generate a notification indicating the second set of parameter values.

In some implementations, the first request may comprise a request to obtain resources in connection with acquiring a property such that the obtained resources are transferred to the data record associated with the property.

In some implementations, the first set of parameter values may include at least one of: a loan amount; a loan term; an amortization period; or a down payment amount.

In some implementations, the first criteria for evaluating the first request may include at least one of: a total debt service ratio; a gross debt service ratio; or a loan-to-value ratio.

In some implementations, determining modifications to at least one parameter value of the first set may include determining a candidate value of the at least one parameter that is different from a current value of the at least one parameter.

In some implementations, determining modifications to at least one parameter value of the first set may include determining candidate values of a plurality of parameters that are different from current values of said parameters.

In some implementations, determining modifications to at least one parameter value of the first set may include determining a plurality of different sets of parameter values that satisfy the first criteria.

In some implementations, generating the notification may include: selecting one of the plurality of different sets of parameter values; and generating a notification indicating the selected set of parameter values.

In some implementations, the instructions, when executed, may further configure the processor to cause the notification to be displayed on a user interface of a client device associated with the first request.

In some implementations, causing the notification to be displayed may include causing a user interface element corresponding to a selectable option for a further evaluation of the first request to be displayed on the client device.

In another aspect, a computer-implemented method is disclosed. The method includes: receiving a first request to obtain a first quantity of resources in connection with a data record; identifying a first set of parameter values for the first request, the first set including at least one automatically modifiable parameter value; determining first criteria for evaluating the first request, the first criteria including defined rules associated with one or more of the first set of parameter values; determining that the first request does not satisfy the first criteria; in response to determining that the first request does not satisfy the first criteria: determining modifications to at least one parameter value of the first set to obtain a second set of parameter values for a second request that satisfies the first criteria; and generating a notification indicating the second set of parameter values.

In yet another aspect, a non-transitory computer readable storage medium is disclosed. The computer readable storage medium contains instructions thereon which, when executed by a processor, configure the processor to: receive a first request to obtain a first quantity of resources in connection with a data record; identify a first set of parameter values for the first request, the first set including at least one automatically modifiable parameter value; determine first criteria for evaluating the first request, the first criteria including defined rules associated with one or more of the first set of parameter values; determine that the first request does not satisfy the first criteria; in response to determining that the first request does not satisfy the first criteria: determine modifications to at least one parameter value of the first set to obtain a second set of parameter values for a second request that satisfies the first criteria; and generate a notification indicating the second set of parameter values.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Requests to obtain resources may be received and processed by resource lender systems. These systems may adjudicate resource requests based on defined criteria, such as adjudication rule sets. For example, nodes of a computer network may generate and send requests to acquire additional computing resources from a network resource management system, and the system may determine how to allocate the resources of the network. As another example, applications to receive loans (e.g., mortgages) that are in the form of resource requests may be directed to a financial institution server (and more generally, a loan originating system). A loan adjudication entity associated with the financial institution may approve or deny a loan application.

The adjudication of resource requests can be a prolonged process, particularly when a large volume of requests is handled by a small number of adjudicating entities. Timely resolution of resource requests is desirable, particularly for lender entities that offer resource loans as products. In particular, if a lender entity's loan origination process is complicated or protracted, customers may be driven to search for alternative products and/or sources of loans.

The present application discloses solutions for automatically adjudicating resource requests. A computing system associated with a resource request adjudicating entity is described. When the system receives a resource request to obtain resources in connection with a data record (and/or resource account), the system identifies a first set of parameter values associated with the resource request. The system also determines suitable criteria for evaluating the resource request, the criteria including defined rules relating to the parameter values. If the system determines that the resource request does not satisfy the evaluation criteria, the system is configured to automatically determine modifications to one or more of the parameter values to obtain a second set of parameter values that will satisfy the evaluation criteria. A notification indicating the modified parameter values may then be provided to the resource requesting entity.

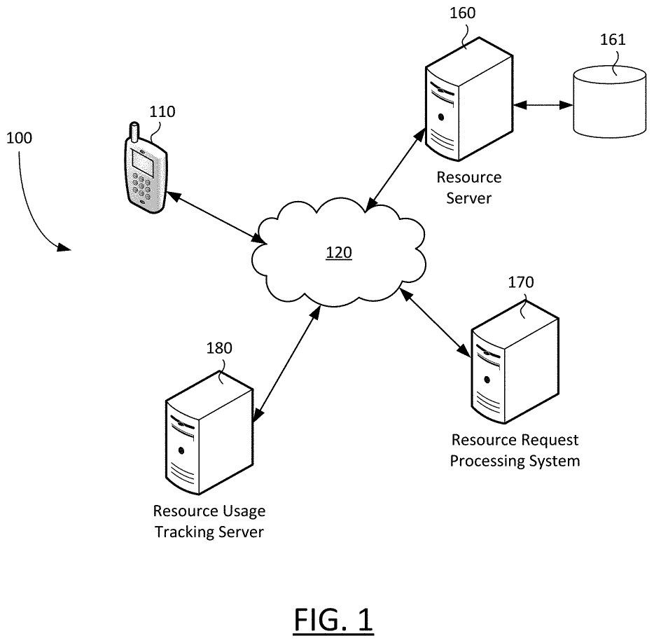

Reference is first made to FIG. 1, which is a schematic diagram illustrating an operating environment of an example embodiment. FIG. 1 illustrates exemplary components of a system 100 for processing resource requests data. As a specific example, the system 100 of FIG. 1 may be implemented to facilitate processing of loan (e.g., mortgage) applications in connection with resource accounts of borrower entities.

As shown in FIG. 1, a resource server 160 (which may also be referred to as a server computer system) and client device 110 communicate via the network 120. The client device 110 is a computing device associated with an entity having resources that are associated with the resource server 160. For example, the client device 110 may be associated with a customer of an institution that manages the resource server 160. The client device 110 may take a variety of forms including, for example, a mobile communication device such as a smartphone, a tablet computer, a wearable computer such as a head-mounted display or smartwatch, a laptop or desktop computer, or a computing device of another type.

The resource server 160 may track, manage, and maintain resources, make lending decisions, and/or lend resources to a borrower (e.g., customer) entity. The resources may, for example, be computing resources, such as memory or processor cycles. By way of further example, the resources may include stored value, such as fiat currency, which may be represented in a database. For example, the resource server 160 may be coupled to a database 161, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

In some embodiments, the system 100 may include a resource request processing system 170. A resource request processing system 170 may implement a service which receives resource requests and automatically processes the resource requests to render resource lending approval decisions for requesting entities. This adjudication service may be implemented by a server that is different from the resource server 160. For example, a resource request processing system 170 that is communicably connected to the resource server 160 and has access to resource accounts data maintained by the resource server 160 may be configured to provide an adjudication service for resource requests. In particular, the resource request processing system 170 may provide resource lending decisions (i.e., loan approval or denial) for the customer entities that are associated with the resource accounts of the resource server 160.

While FIG. 1 illustrates the resource server 160 and the resource request processing system 170 as being independent components of the system 100, it will be understood that the functions of the resource request processing system 170 may be implemented by the resource server 160. For example, the resource server 160 may include (or have access to) a resource request processing engine that is configured to receive resource requests associated with one or more resource accounts of the resource server 160 and automatically adjudicate such requests.

The database 161 may include data records for a plurality of accounts and at least some of the data records may define a quantity of resources associated with an entity. For example, the entity that is associated with the client device 110 may be associated with an account having one or more data records in the database. The data records may reflect a quantity of stored resources that are associated with the customer entity. Such resources may include owned resources and, in at least some embodiments, borrowed resources (e.g., resources available on credit). The quantity of resources that are available to or associated with an entity may be reflected by a balance defined in an associated data record such as, for example, a bank balance.

The resource server 160 may, for example, be a financial institution server that is operated by a financial institution and the entity may be a customer of the financial institution.

The resource server 160 may be in communication with a resource usage tracking server 180 via the network 120. The resource usage tracking server 180 may maintain a history of resource borrowing by various entities including, for example, the entity associated with the client device 110 and associated with an account having one or more data records in the database 161.

Additionally, or alternatively, the resource usage tracking server 180 may maintain historical resource usage data associated with the various entities. Such data may be maintained on a per-entity basis, with each entity having its own associated historical resource usage data. The historical resource usage data may identify, for example, third parties that have a credit relationship with the entity associated with a particular instance of the historical resource usage data, such as a particular record of the historical resource usage data. The historical resource usage data may, for example, be a credit report. A credit report is a record of a borrower's credit history from a number of sources including, for example, credit card companies, banks, collection agencies and/or governments. A credit score, which is a numerical representation of a borrower's creditworthiness, may be obtained based on a credit report. The historical resource usage data, such as the credit report, may identify various resource event data including, any one or a combination of: a borrowed resource history (e.g., a credit history), a resource transfer history (e.g., a record of payments including, for example, an indication of whether such payments were on time or late), failed transfer information (e.g., information regarding cheques that were returned for having non-sufficient funds and/or information about accounts that were sent to a collection agency, bureau or process due to non-transfer of resources), resource shortage information (e.g., data regarding prior bankruptcies or other data indicating that an entity had insufficient resources to satisfy data transfer requirements), borrowed resource information (e.g., information about loans including secured and unsecured loans), and/or data of another type.

In some embodiments, the resource event data may include a third-party identifier. The third-party identifier may, for example, be a name of a third party that is associated with such data. The name of a third party that added or caused to be added an entry to the historical resource usage data may be identified. By way of example, the resource transfer history may identify a plurality of third parties who have a past history of requesting and/or receiving transfers from the entity. By way of further example, the failed transfer information may identify a third party that was to be the recipient of the failed transfer. By way of further example, the borrowed resource information may identify a third party that previously lent resources to the entity.

In some embodiments, the resource event data may include identification information that a defined third-party would associate with the entity. For example, an account number, a partial account number, or other customer identifier may be included in the historical resource usage data. By way of example, the historical resource usage data may indicate that a given third party (e.g., “The Phone Company”) identifies the entity with a defined account number (e.g., 798126).

The historical resource usage data may include other information instead of or in addition to the information defined above. For example, the historical resource usage data may include a listing of third parties that have previously retrieved and/or requested historical resource usage data maintained by the resource usage tracking server 180 (e.g., a listing of third parties that previously requested a credit report). By way of further example, the historical resource usage data may include identification and/or biographical information for the entity. Such information may include, for example, any one or more of: a name, address, date of birth, marital status, current and/or past employment information (e.g., a title, a date of employment, income amount, name of employer, etc.), contact information (such as a telephone number, etc.), a government issued identification number (e.g., a social insurance number (SIN), a passport number and/or driver's license number), or other information.

Various entries of data, such as, for example, the resource event data, may include a date associated therewith. The date may, for example, be a reporting and/or verification date. The date may reflect freshness of the associated entry of data such that entries with a more recent date may be considered to be fresher than entries with an older date.

The resource usage tracking server 180 may include an application programming interface (API) that allows the resource server 160 to request for and receive historical resource usage data for an entity. By way of example, the API may allow the resource server 160 to retrieve the historical resource usage data for an entity by sending a message which includes identification information for the entity to the resource usage tracking server 180. The identification information may, for example, include any one or combination of: a name, government issued identification number, an address, a date of birth, contact information (e.g., a telephone number), or identification of another type. The resource usage tracking server 180 uses such identification information to retrieve a historical resource usage data associated with the entity. For example, an appropriate record in a database may be retrieved based on the identification information. The resource usage tracking server 180 may then send the historical resource usage data for the entity to the resource server 160.

As described above, the client device 110, the resource server 160, the resource request processing system 170, and the resource usage tracking server 180 may be computer systems. The client device 110, the resource server 160, the resource request processing system 170, and the resource usage tracking server 180 may be in geographically disparate locations. Put differently, the client device 110 may be remote from at least one of the resource server 160, the resource request processing system 170, and the resource usage tracking server 180.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 160 may provide both data transfer processing (e.g., bill payment) and data holding (e.g., banking) functions. That is, the resource server 160 may be both a financial institution server and also a bill payment processing server. The resource server 160 may, in some embodiments, be a proxy server, serving as an intermediary for requests for client devices 110 seeking resources from other servers. For example, the resource server 160 may be a proxy connecting client devices 110 to servers or data stores storing vehicle data (e.g., make, model, price, etc.) for a plurality of vehicles.

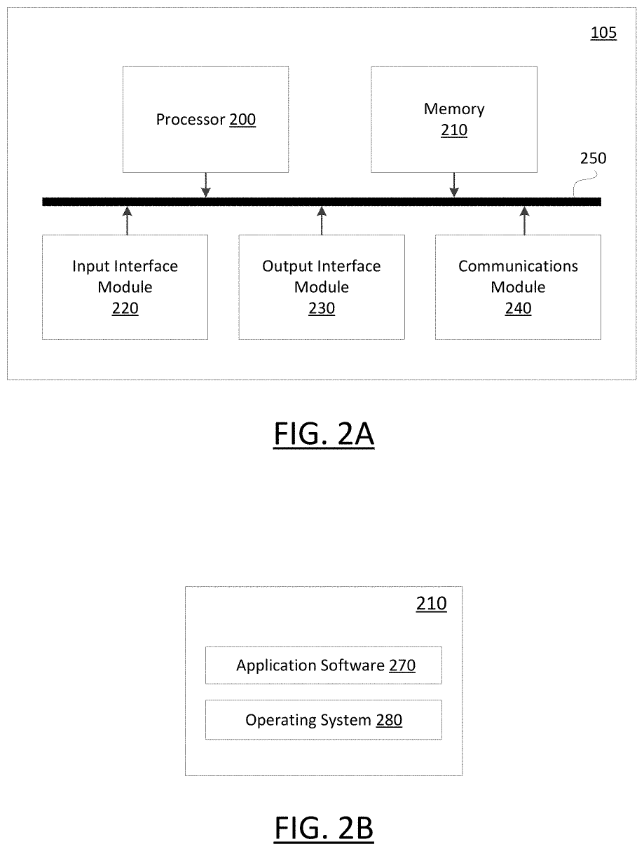

FIG. 2A is a high-level operation diagram of the example computing device 105. In at least some embodiments, the example computing device 105 may be exemplary of one or more of the client device 110, the resource server 160, the resource request processing system 170, and the resource usage tracking server 180. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components may include application software 270 and an operating system 280.

The application software 270 adapts the example computing device 105, in combination with the operating system 280, to operate as a device performing particular functions. In some embodiments, the application software 270 may comprise a resource account management application. The resource account management application may, for example, be a personal banking application that is used to manage one or more banking accounts. The resource account management application may provide various functions such as resource transfers (e.g., electronic fund transfers, etc.), display of account balances, and other account management functions. For example, the resource account management application may enable users to configure requests to obtain resources in connection with their resource account. In particular, the resource account management application may be used to generate resource requests. A user may input information, or parameters, for defining a resource request such as identifying information for the requester, quantity of resources requested, value of assets owned (e.g., properties, automobiles, investments, etc.), employment information, and asset purchase information for which resources are requested. Once it is defined, the resource request can be transmitted, via the resource account management application, to a computing system for processing resource requests. For example, the resource request may be transmitted to a request adjudication system, such as the resource request processing system 170.

While a single application software 270 is illustrated in FIG. 2B, in operation, the memory 210 may include more than one application software 270 and different application software 270 may perform different operations.

The operating system 280 is software. The operating system 280 allows the application software 270 to access the processor 200, the memory 210, the input interface module 220, the output interface module 230 and the communications module 240. The operating system 280 may be, for example, Apple iOS™, Google™'s Android™, Linux™, Microsoft™ Windows™, or the like.

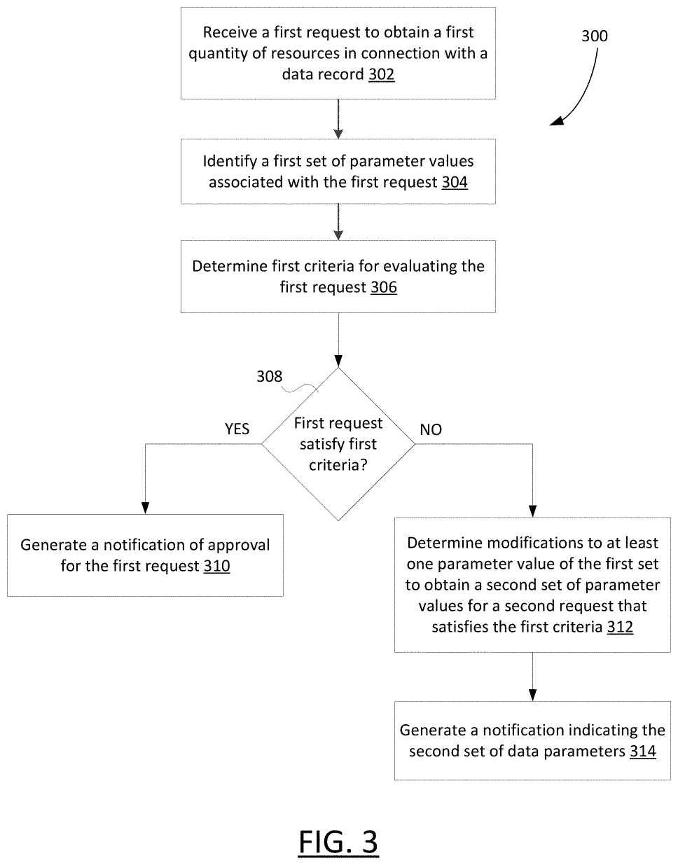

Reference is made to FIG. 3, which shows, in flowchart form, an example method 300 for processing resource requests in real-time. The method 300 may enable a computing system to automatically adjudicate resource requests to render resource lending approval decisions for requesting entities. In particular, approval decisions may be provided to the requesting entities in real-time (or near real-time). Operations 302 and onward are performed by one or more processors of a computing device such as, for example, the processor 200 (FIG. 2) of a suitably configured instance of the example computing device 105 (FIG. 2). The method 300 may be implemented, for example, by a computing system, such as the resource requesting processing system 170, that is configured for handling resource requests in connection with one or more data records (and associated resource accounts) of a database.

In operation 302, the computing system receives a first request to obtain a first quantity of resources in connection with a data record. The first request may comprise a message for requesting to obtain certain resources from a lender entity. For example, the first request may be a request to obtain resources in connection with acquiring a property (e.g., a house) such that the obtained resources are transferred to a data record (or resource account) associated with the property. In at least some embodiments, the first request is transmitted via a client device associated with a borrower entity. For example, a user interface, such as a mobile or web application, that is accessible on the client device may be used to generate and forward a resource request to the computing system. The user interface may allow the requesting entity to define various terms of the first request. The requesting entity may, for example, input information relating to a resource loan, such as identifying information for the borrower, quantity of resources requested (i.e., loan amount), loan term, amortization period, value of assets owned (e.g., properties, automobiles, investments, etc.), employment information, asset purchase information for which resources are requested, down payment amount, etc., via the user interface.

In some embodiments, the first request may be a request for an approval decision in connection with acquisition of resources. In particular, the first request may represent a request for an indication of whether the requesting entity is qualified to acquire the first quantity of resources. For example, an applicant for a resource loan may generate the first request to receive an approval (or pre-approval) decision, from a resource request processing system, in connection with the resource loan.

In operation 304, the computing system identifies a first set of parameter values associated with the first request, the first set including at least one automatically modifiable parameter value. Specifically, upon receiving the first request, the computing system determines request data of the first request. The request data may be identified based on the request message of the first request. The request data may be determined, for example, by identifying values of defined data fields indicated in the request message. That is, the first set of parameter values may include inputted values of data fields that are provided by the resource requesting entity. For example, the computing system may parse text associated with request message of the first request in order to determine the first set of parameter values.

In at least some embodiments, the computing system may only identify values of a predefined list of data fields from the first request. That is, not all values of data fields associated with the first request may be included in the first set of parameter values. As will be further explained below, the first set may only include those values that are used in evaluating whether the first request satisfies certain defined criteria.

In operation 306, the computing system determines first criteria for evaluating the first request. The first criteria include rules defining various conditions that are required to be met in order for a resource request to be approved by the computing system. The first criteria are used to evaluate the request data of the first request. In particular, the first criteria include rules associated with one or more of the first set of parameter values. By way of example, if the first request is a request for a loan (e.g., a mortgage), the first criteria may include rules relating to at least one of: a total debt-service ratio, a gross debt-service ratio, or a loan-to-value ratio. More generally, the first criteria may include various metrics and associated threshold values for the metrics. The metrics may comprise one or more measurements that relate to account data for resource accounts of the requesting entity. The first criteria may define rules associated with the thresholds, such that a parameter value may be determined to satisfy the first criteria if said value satisfies a rule associated with a relevant threshold.

In at least some embodiments, the first criteria are stored in memory associated with the computing system. Specifically, the computing system may store adjudication rule sets that are used for evaluating resource requests. A plurality of different adjudication rule sets may be stored, and the computing system may be configured to selectively apply the adjudication rules. In particular, the computing system may select one or more adjudication rule sets for use in evaluating a resource request based on request data associated with the resource request. That is, the adjudication rule set that is retrieved by the computing system may depend on the particular resource request being evaluated by the computing system. For example, upon receiving a resource request, the computing system may identify a type (e.g., loan, mortgage, etc.) associated with the resource request and select one or more of the stored adjudication rule sets to apply in evaluating the resource request.

In operation 308, the computing system determines whether the first request satisfy the first criteria. The first criteria may, for example, define thresholds and associated rules with respect to values of one or more defined data fields, and the computing system may compare the first set of parameter values against the thresholds to determine whether the parameters associated with the first request satisfy the associated rules.

If the first criteria are satisfied, the computing system generates a notification of approval for the first request, in operation 310. For example, if the first set of parameter values satisfy all or a selected subset of the first criteria, the computing system may determine that the first request satisfy the first criteria and an indication of approval may be generated. A notification indicating the approval of the first request may then be presented to the requesting entity. For example, the notification may be transmitted to a client device associated with the requesting entity to be displayed via a user interface thereon.

If, on the other hand, the first request does not satisfy the first criteria, the computing system proceeds to automatically determine modifications to the first request. In particular, in response to determining that the first request does not satisfy the first request, the computing system determines modifications to one or more parameters of the first set to obtain a second set of parameter values (i.e., a modified parameter set) that satisfies the first criteria, in operation 312.

The first request is defined by input of parameter values by a resource requesting entity. If the parameter values of the first request do not satisfy the first criteria (and more generally, a defined adjudication rule set for evaluating the request), it is desirable to provide, to the resource requesting entity, information which may be used to modify, or update, their resource request such that the request would be, or is more likely to be, approved. In accordance with embodiments of the present disclosure, the computing system may determine proposed modifications to parameter values of the first request based on the first criteria. The modified parameter values may then be used for defining a second request to obtain resources in connection with the data record (and associated resource account) that the computing system would approve.

In some embodiments, at least one of the automatically modifiable parameter values of the first set may be varied. In particular, the computing system may determine a candidate value of the at least one parameter that is different from a current value of said parameter. The candidate value may be greater or less than the current value of the parameter, depending on the relevant threshold and associated rule as defined by the first criteria (e.g., adjudication rule set).

The first set of parameters associated with the first request may include a subset of parameters that are modifiable. For example, the computing system may be configured to determine modified values for one or more predefined parameters associated with the first request, and provide an indication of the modified values to the resource requesting entity. The modified values may represent the parameter values for one or more alternative requests, i.e., different from the first request, to obtain resources in connection with the data record/resource account.

In at least some embodiments, the determination of modified values may be performed in accordance with predetermined rules. Specifically, rules governing the modification of parameter values associated with resource requests may be defined. The rules may, for example, indicate the types of modifications that are permissible for values of one or more of the automatically modifiable parameters. By way of example, the rules may relate to limits (i.e., upper and lower limits) on parameter values, possible discrete values of one or more parameters, and amount of permissible change of parameter value.

The computing system may determine candidate values of the modifiable parameters based on such rules. In particular, the candidate values may be values that satisfy a relevant adjudication rule set for evaluating the first request and that are determined in accordance with rules relating to modification of parameter values. The second set of parameter values may be a set that is different from the first set by at least one parameter value. The different parameter value may, for example, be a candidate value that is determined for the at least one parameter by the computing system.

In operation 314, the computing system generates a notification indicating the second set of parameter values. That is, once the second set is determined by the computing system, a notification identifying the parameters of the second set may be generated for presenting to the resource requesting entity. In particular, the notification may identify the parameter values of the first set that are varied to obtain the second set and the modified values of said parameters.

The notification identifying the second set may be provided in real-time or near real-time after receiving the first request. By way of example, if the first request is received via a user interface on a client device of a resource requesting entity, the computing system may be configured to present a notification identifying the set of modified parameter values on the same user interface. The first request may, for example, be generated during a browsing session on the client device, and a resource lending decision in connection with the first request may be provided in real-time (or near real-time) on the client device. In this way, the client device may display, via a user interface, the modified parameters for an approvable resource request as part of a response to the first request.

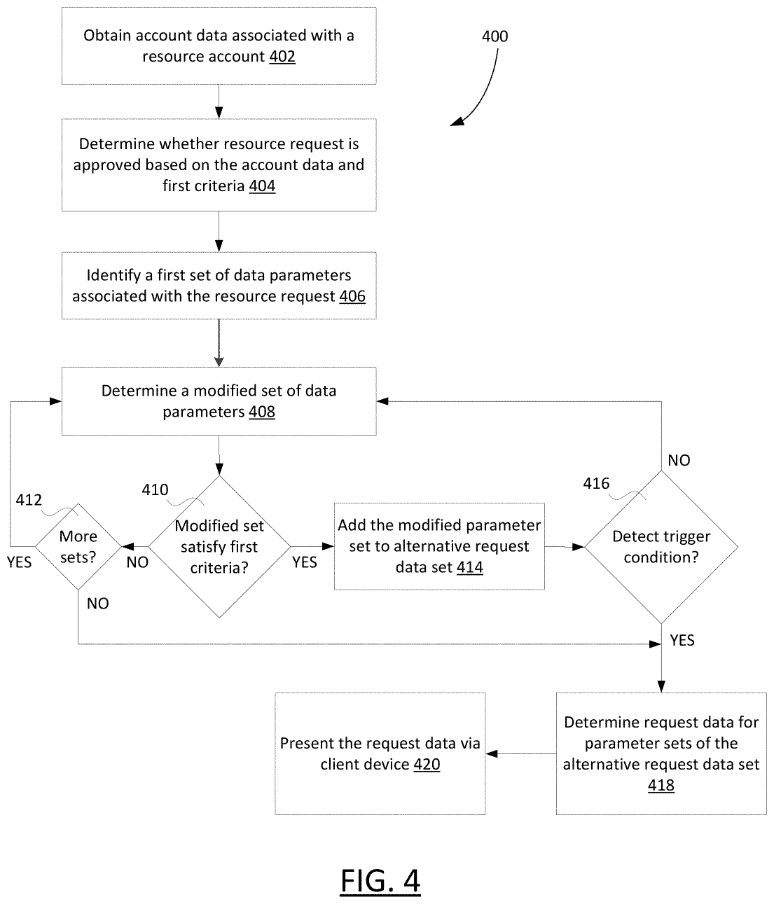

Reference is made to FIG. 4, which shows, in flowchart form, an example method 400 for determining request data for one or more alternative resource requests. The method 400 may enable a computing system to automatically determine alternative, or modified, parameter sets for a given resource request. Operations 402 and onward are performed by one or more processors of a computing device such as, for example, the processor 200 (FIG. 2) of a suitably configured instance of the example computing device 105 (FIG. 2). The method 400 may be implemented, for example, by a computing system, such as the resource requesting processing system 170, that is configured for handling resource requests in connection with one or more data records (and associated resource accounts) of a database. The operations of method 400 may be performed in addition to, or as alternatives of, one or more operations of method 300.

A computing system may receive a first request to obtain resources in connection with a resource account. In some embodiments, the first request may comprise a request for a resource loan associated with acquisition of an asset (e.g., a property). The computing system may render a resource lending decision in connection with the first request. In operation 402, the computing system obtains account data associated with the resource account. For example, the computing system may obtain, from a resource management server associated with the resource account, account data such as account identifying information, current balance of resources, historical account operations data, and the like. The account data may be obtained, for example, by querying a data store (e.g., a database) associated with the resource management server to retrieve data for the resource account.

The computing system may store one or more adjudication rule sets for evaluating resource requests associated with a plurality of resource accounts. An adjudication rule set may define criteria that are used to determine whether a resource request should be approved. The computing system may identify a suitable adjudication rule set (i.e., first criteria) for the first request and in operation 404, the computing system determines whether the resource request is approved based on the account data and the first criteria. That is, the computing system adjudicates the first request. In particular, a resource lending decision may be rendered based on both the account data of the resource account associated with the resource requesting entity and the first criteria (and more generally, an adjudication rule set selected for the first request). The adjudication may be performed by comparing the parameter values of the first request and account data values with the first criteria to determine whether all or at least a subset of the first criteria are satisfied.

If the first request is not approved, the computing system may be configured to provide, to the requesting entity, information for deriving a modified resource request that is approvable by the computing system based on the first criteria. In operation 406, the computing system identifies a first set of parameter values associated with the first request. The first set may include values of a plurality of defined data fields of the first request. In particular, the first set may include those values that are inputted by a requesting entity when generating the first request.

The computing system then determines a modified set of parameter values, in operation 408. For example, the computing system may vary one of the values of the first set (i.e., value of a selected parameter) to obtain a modified parameter value set. In some embodiments, only a subset of the first set of parameter values may be modified. In particular, only a select number of predetermined parameter values of the first set may be varied to obtain the modified parameter value set. The value of the selected parameter may be varied by a fixed and predefined amount. That is, the value is not adjusted arbitrarily; instead, it may be adjusted in accordance with predefined rules for varying the selected parameter value.

The modification of at least one parameter value of the first request may be performed based on defined rules governing modifying of parameter values (such as those described above with reference to FIG. 3) and/or based on the account data of a resource account associated with the resource requesting entity. In some embodiments, the modified values of parameters may be determined based on account data such as, for example, current balance of resources, historical account operations data, and the like.

In operation 410, the computing system determines whether the modified parameter value set satisfies the first criteria. For example, the first criteria may include various metrics and associated threshold values, and the computing system may compare the modified parameter value set to the defined thresholds. If the modified parameter set is determined to satisfy the first criteria, the computing system adds the modified parameter set to an alternative request data set, in operation 414. The alternative request data set represents a set of parameter sets corresponding to resource requests that are approvable by the computing system.

If, on the other hand, the modified parameter set does not satisfy the first criteria, the computing system determines if there are more possible modifications to the first parameter set (operation 412) and iterates through the process of deriving different modified parameter sets and comparing them against the first criteria to determine whether the resource requests associated with said modified parameter sets are approvable. In this way, the computing system may determine a plurality of different sets of parameter values that satisfy a selected adjudication rule set. The different parameter sets correspond to modified resource requests that are different from the first request. For example, the computing system may determine candidate values of a plurality of parameters that are different from current values of said parameters. That is, values of multiple ones of the first set of parameter values may be varied to determine candidate values that would result in a modified resource request being approved. In some embodiments, limits (e.g., upper and lower limits) on values of parameters may be predefined such that values may be varied only within the defined limits.

If the computing system determines that there are no more variations of the first parameter set, the computing system determines request data associated with the modified parameter sets of the alternative request data set, in operation 418. Alternatively, if the computing system detects a defined trigger condition in operation 416, the request data for the modified parameter sets already included in the alternative request data set may be determined. The trigger condition may be detected, for example, when a threshold number of parameter sets are determined to be included in the alternative request data set. As another example, the trigger condition may be detected if the computing system determines that a parameter set that complies with defined preferences has been added to the alternative request data set. Such preferences may be defined by either the resource requesting entity or the resource lending entity. The request data of a modified resource request includes, at least, an indication of the parameters that have been modified from the first set of parameter values and the values associated with said modified parameters.

The request data for the modified resource requests is then presented via the client device, in operation 420. In some embodiments, the computing system may select one (or a subset) of the plurality of different sets of modified parameters and generate a notification indicating the selected modified parameter set. The selection of the single modified parameter set may be performed based on a defined priority ranking representing a ranking of significance of the parameter values. For example, the selected modified parameter set may be a set that includes a modification to a parameter that is ranked highest in a priority ranking of parameter values associated with the first request.

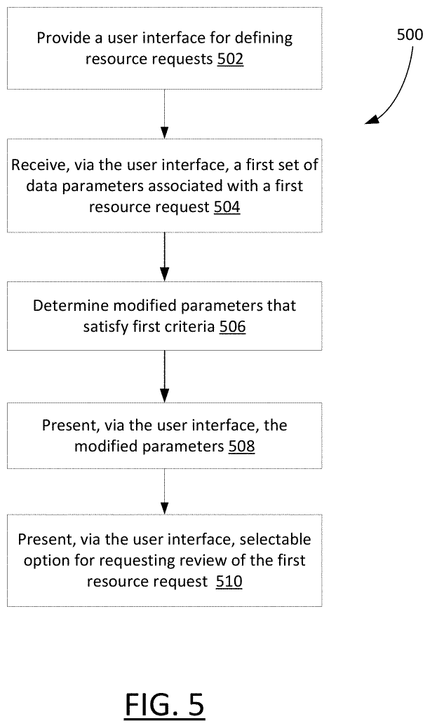

Reference is made to FIG. 5, which shows, in flowchart form, an example method 500 for providing display data of a user interface for requesting resources. The method 500 may enable a computing system to provide, on a client device associated with a resource requesting entity, a user interface which may be used for generating, modifying, and monitoring resource requests of a client entity. Operations 502 and onward are performed by one or more processors of a computing device such as, for example, the processor 200 (FIG. 2) of a suitably configured instance of the example computing device 105 (FIG. 2). The method 500 may be implemented, for example, by a computing system, such as the resource requesting processing system 170, that is configured for handling resource requests in connection with one or more data records (and associated resource accounts) of a database. The operations of method 500 may be performed in addition to, or as alternatives of, one or more operations of methods 300 and 400.

In operation 502, the computing system provides a user interface for defining resource requests. The user interface may, for example, be a graphical user interface of an application (e.g., a mobile or web application) which may be used for inputting parameter values associated with a resource request. In some embodiments, the user interface may be a GUI of a personal banking application or a webpage (accessible via a web browser) that allows a customer entity to input a request to obtain a resource loan (e.g., a mortgage).

The computing system receives, via the user interface, a first set of parameter values associated with a resource request, in operation 504. The first set includes values of parameters that are inputted by the resource requesting entity in connection with the resource request. If the computing system determines that the resource request and more particularly, the associated parameter values of the resource request, do not satisfy a selected adjudication rule set (e.g., first criteria) suitable for evaluating the resource request, the computing system determines a set of modified parameters, in operation 506. The modified parameter set represents a set of parameters that is different from the first set in at least one parameter value. The modified parameter set is determined such that the parameters of said set satisfy the adjudication rule set. That is, the modified parameter set corresponds to a modified resource request that is approvable based on the adjudication rule set.

The computing system then presents the modified parameter set via the user interface, in operation 508. In some embodiments, the modified parameter set may be presented as part of a response to the resource request. For example, the values of the modified parameter set may be displayed as request data for an alternative to the initial resource request that is approvable, in response to the requesting entity submitting the resource request. In operation 510, the computing system also presents, via the user interface, a selectable option for requesting review of the initial resource request. For example, a user interface element associated with a selectable option may be displayed simultaneously with the request data for the alternative resource request that is approvable. In particular, the selectable option and the request data for the alternative resource request may be displayed within a defined region of the user interface. While the initial resource request may have been denied by the automated adjudication system administered by the computing system, the requesting entity may wish to request a secondary review of the parameters of the initial resource request. The simultaneous display of the selectable option allows a requesting entity to either accept the modified parameter set of the alternative resource request or request further review of the initial resource request. The former corresponds to an approval decision that is instantly available (i.e., upon acceptance of the modified parameter set) and the latter corresponds to a secondary review process that is not instantly available (e.g., the selectable option may initiate a manual review of the initial resource request).

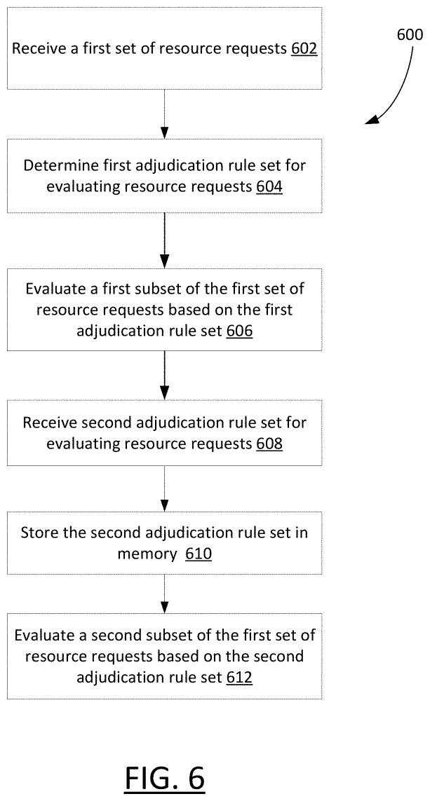

Reference is made to FIG. 6, which shows, in flowchart form, an example method 600 for dynamically updating adjudication rules for a resource request processing system. The method 600 may enable a computing system to automatically store and enforce updated rules for adjudicating resource requests. Specifically, a resource request processing entity may apply rules which may be dynamically updated, in accordance with the method 600. Operations 602 and onward are performed by one or more processors of a computing device such as, for example, the processor 200 (FIG. 2) of a suitably configured instance of the example computing device 105 (FIG. 2). The method 600 may be implemented, for example, by a computing system, such as the resource requesting processing system 170, that is configured for handling resource requests in connection with one or more data records (and associated resource accounts) of a database. The operations of method 600 may be performed in addition to, or as alternatives of, one or more operations of methods 300, 400 and 500.

A resource request processing system may store adjudication rule sets that are used for evaluating resource requests. The adjudication rule sets may be dynamically updated, for example, by a resource management entity associated with the resource request processing system. For example, the metrics and associated threshold values may be changed from time-to-time by a resource lending entity (e.g., a financial institution). In accordance with embodiments of the present disclosure, a resource request processing system may be configured to deploy, in real-time, new (or modified) adjudication rules for evaluating resource requests.

In operation 602, the computing system receives a first set of resource requests. The first set may include a plurality of resource requests originating from one or more resource requesting entities. The computing system determines a first adjudication rule set for evaluating the resource requests of the first set, in operation 604. The first adjudication rules may, for example, include one or more adjudication rules for evaluating the resource requests of the first set. The first adjudication rules a may be determined based on information relating to the resource requests. That is, the selection of the first adjudication rules may depend on request data of the resource requests of the first set. The first adjudication rules may comprise rules data that are stored in memory associated with the computing system.

In operation 606, the computing system evaluates a first subset of the first set of resource requests based on the first adjudication rule set. That is, a select number of the first set of resource requests is evaluated using the first adjudication rule set accessible by the computing system. The resource requests of the first set may be evaluated in a chronological order, based on time of receipt or generation of the resource request. For example, the first subset of resource requests that are evaluated may include those resource requests that are the earliest received requests by the computing system.

In operation 608, the computing system receives a second adjudication rule set for evaluating resource requests. The second adjudication rule set may be a modification (or update) of the first adjudication rule set or an entirely different rule set. In particular, the second adjudication rule set may comprise adjudication rules that are applicable for evaluating the resource requests of the first set. Accordingly, it is desirable for the second adjudication rule set to be timely deployed for evaluating the first set of resource requests.

The computing system stores the second adjudication rule set in memory, in operation 610. After storing the rules in memory, the computing system evaluates a second subset of the first set of resource requests based on the second adjudication rule set, in operation 612. In particular, the second subset includes one or more of the resource requests that were not included in the first subset. For example, the second subset may include those resource requests that were received (or generated) later than the resource requests of the first subset. More generally, the first and second subsets of the resource requests are distinct sets, and the second adjudication rule set is used for evaluating only the resource requests of the second subset.

Further, the second adjudication rule set may be used by the computing system for evaluating future resource requests that are received by the computing system. That is, the resource requests that are received subsequent to receipt of the resource requests of the first set may be evaluated using the second adjudication rule set.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
and
a memory coupled to the processor, the memory storing computer-executable instructions that, when executed by the processor, configure the processor to:
receive, via a graphical user interface on a client computing device, a first request to obtain a first quantity of resources in connection with a data record;
identify a first set of parameter values associated with the first request, the first set including at least one automatically modifiable parameter value;
determine first criteria for evaluating the first request, the first criteria including defined rules associated with one or more of the first set of parameter values;
determine that the first request does not satisfy the first criteria based on comparing parameter values of the first set against defined thresholds and evaluating rules associated with the defined thresholds;
in response to determining that the first request does not satisfy the first criteria:
determine modifications to one or more automatically modifiable parameter values of the first set to obtain a second set of parameter values that satisfies the first criteria;
provide, to the client computing device for display via the graphical user interface in real-time responsive to receipt of the first request:
request data for an alternative resource request comprising parameter values of the second set; and
a user interface element associated with a selectable option for requesting review of the first request, the user interface element and the request data displayed concurrently in a defined same region of the graphical user interface.

2. The computing system of claim 1, wherein the first request comprises a request to obtain resources in connection with acquiring a property such that the obtained resources are transferred to the data record associated with the property.

3. The computing system of claim 2, wherein the first set of parameter values includes at least one of: a loan amount; a loan term; an amortization period; or a down payment amount.

4. The computing system of claim 1, wherein the first criteria for evaluating the first request includes at least one of: a total debt service ratio; a gross debt service ratio; or a loan-to-value ratio.

5. The computing system of claim 1, wherein determining modifications to at least one parameter value of the first set comprises determining a candidate value of the at least one parameter that is different from a current value of the at least one parameter.

6. The computing system of claim 1, wherein determining modifications to at least one parameter value of the first set comprises determining candidate values of a plurality of parameters that are different from current values of said parameters.

7. The computing system of claim 1, wherein determining modifications to at least one parameter value of the first set comprises determining a plurality of different sets of parameter values that satisfy the first criteria.

8. (canceled)

9. (canceled)

10. (canceled)

11. A computer-implemented method, comprising:
receiving a first request to obtain a first quantity of resources in connection with a data record;
identifying a first set of parameter values for the first request, the first set including at least one automatically modifiable parameter value;
determining first criteria for evaluating the first request, the first criteria including defined rules associated with one or more of the first set of parameter values;
determining that the first request does not satisfy the first criteria;
in response to determining that the first request does not satisfy the first criteria:
determining modifications to at least one parameter value of the first set to obtain a second set of parameter values that satisfies the first criteria; and
generating a notification indicating the second set of parameter values.

12. The method of claim 11, wherein the first request comprises a request to obtain resources in connection with acquiring a property such that the obtained resources are transferred to the data record associated with the property.

13. The method of claim 12, wherein the first set of parameter values includes at least one of: a loan amount; a loan term; an amortization period; or a down payment amount.

14. The method of claim 11, wherein the first criteria for evaluating the first request includes at least one of: a total debt service ratio; a gross debt service ratio; or a loan-to-value ratio.

15. The method of claim 11, wherein determining modifications to at least one parameter value of the first set comprises determining a candidate value of the at least one parameter that is different from a current value of the at least one parameter.

16. The method of claim 11, wherein determining modifications to at least one parameter value of the first set comprises determining candidate values of a plurality of parameters that are different from current values of said parameters.

17. The method of claim 11, wherein determining modifications to at least one parameter value of the first set comprises determining a plurality of different sets of parameter values that satisfy the first criteria.

18. (canceled)

19. (canceled)

20. (canceled)

21. The computing system of claim 1, wherein the request data for the alternative resource request is presented as part of a response to the first request.

22. The computing system of claim 1, wherein determining modifications to the one or more automatically modifiable parameter values comprises adjusting the at least one of the parameter values in accordance with predefined rules for varying selected parameter values and account data of a resource account.

23. The computing system of claim 1, wherein selection of the user interface element initiates a request for manual review of the first request.

24. The method of claim 11, wherein the request data for the alternative resource request is presented as part of a response to the first request.

25. The method of claim 11, wherein determining modifications to the one or more automatically modifiable parameter values comprises adjusting the at least one of the parameter values in accordance with predefined rules for varying selected parameter values and account data of a resource account.

26. The method of claim 11, wherein selection of the user interface element initiates a request for manual review of the first request.
